(19) United States
(12) Patent Application Publication
(10) Pub. No.: US 2009/0225690 A1
(43) Pub. Date: Sep. 10, 2009

(54) NETWORK NODE, A COMMUNICATION NETWORK AND A METHOD OF OPERATION THEREFOR

(75) Inventors: Hong-Yon Lach, Charenton-le-Pont (FR); Imed Romdhani, Edinburgh (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/720,871

(22) PCT Filed: Dec. 9, 2005
(86) PCT No.: PCT/US05/44554

§ 371 Date: Jun. 5, 2007

(30) Foreign Application Priority Data
Jan. 10, 2005 (GB) 0500269.6

(51) Int. Cl. H04L 12/56; H04H 20/71

(52) U.S. Cl. 370/312; 370/390

(57) ABSTRACT

A communication network (100) comprises a roaming network node (109) which may move within the network. The network node (109) comprises a network interface (201) for receiving data from a first node (107) of the network (100). The received data may be multicast data or unicast data. The network node (109) further comprises a multicast processor (205) which determines a multicast characteristic of the first node (107) and an address update processor (207) for selecting between a dynamic address update mode and a non-dynamic address update mode in response to the multicast characteristic. In particular, the network node (109) may operate an address update process, such as a route optimisation or a correspondent registration process, conditionally on whether the foreign network (105) is a multicast node or not. This may improve performance and reduce the signalling overhead associated with route optimisation in a communication network.

### FIELD OF THE INVENTION

The invention relates to a network node, a communication network and a method of operation therefor, and in particular, but not exclusively, to data communication using the Internet Protocol.

### BACKGROUND OF THE INVENTION

The popularity of data networks such as e.g. Local Area Networks (LANs), Wide Area Networks (WANS) and the Internet has increased explosively in the last decades. Furthermore, the provision of mobile data services has become increasingly attractive as evidenced for example by the widespread deployment of cellular communication systems capable of providing data services.

Data communication in networks is typically performed in accordance with a hierarchical model such as the Open Systems Interconnection Reference Model (the OSI model) standardized by the International Organization for Standardization. In accordance with the OSI model, different layers are defined where higher layers pass data to lower layers with each layer being responsible for different aspects of the communication of data. The OSI model defines an interface between the different layers which allows processing of one layer to be independent of processing at lower layers. Thus, communication between network nodes may be considered to be a communication between corresponding layers of the two network nodes.

A number of different data protocols may be used for data communication. One of the most popular data protocols for the Network layer of the OSI model is the Internet Protocol (IP). IP is currently used in many data networks such as the Internet. Most current data networks use version 4 of the Internet Protocol (IPv4). However, IPv4 has a number of limitations including a lack of mobility support, low security and a relatively low number of possible unique addresses.

Accordingly, version 6 of the Internet Protocol (IPv6) is currently being developed and standardized by the Internet Engineering Task Force (IETF). In particular, in order to support IPv6 mobility, the IETF has proposed the Mobile IPv6 protocol as described in David B. Johnson, C. Perkins, J. Arkko “Mobility support in IPv6”, IETF Request for Comments, RFC 3775, June 2004.

A goal of IPv6 is to allow a Mobile Node (MN) to continue communicating with another node, referred to as the Correspondent Node (CN), while moving. Thus, the Mobile IPv6 protocol allows a MN to move from its home link to a foreign link. Each MN is identified by its IP Home Address (HoA) on the home network. When the MN is away from its home link, it will be allocated one or more Care-of Addresses (CoAs) in the foreign network. In order to maintain an undisrupted higher-level session while moving, the MN registers one of the CoAs with its Home Agent (HA) in the home network. The HoA of a MN is linked to the CoA registered in the HA and this association is known as a binding of the HoA to the CoA. The registered address is called the primary Care-of Address (primary CoA).

In order to perform the registration of the primary CoA, the Mobile IPv6 protocol provides for the MN sending a packet containing a Binding Update message to its HA. In response to receiving this binding update, the HA transmits an acknowledgement to the MN and maintains the association of the CoA and the HoA in its Binding Cache. While the MN is away from home, the HA uses proxy the process known as Neighbour Discovery to intercept any packet addressed to the MN's HoA on the home link. When a packet is intercepted, the HA proceeds to encapsulate and send the packet through a tunnel to the primary CoA on the MN's foreign link. Thus, the binding allows for any data packets addressed to the MN's home address to be forwarded to the MN's current address.

In accordance with Mobile IPv6, when the MN receives the tunnelled packet, it proceeds to send a Binding Update message to the Correspondent Node (CN) to notify it of the primary CoA. Accordingly, the CN may be informed of the current address of the MN and this allows the CN to address the MN directly at the current location thereby allowing it to send data directly to the MN without routing through the home network. This procedure is known as the Correspondent Registration procedure. The CN caches and dynamically updates this binding, and can request a new Binding before the expiration of the existing one by sending a Binding Refresh Request message to the MN. Similarly, the HA learns and caches the binding whenever the MN's CoA changes.

Thus, the Correspondent Registration procedure allows for a route optimization and dynamic address update in a data network supporting a roaming MN. However, a disadvantage of procedures such as the Correspondent Registration procedure is that additional messages must be transmitted. For example, Correspondent Registration requires that a large number of Binding Updates are transmitted. Thus, these additional Binding Update messages may use communication resource and reduce the capacity of the communication system.

In addition to mobility, IPv6 also supports multicast communication wherein a single data packet comprising a multicast address is routed to a plurality of network nodes associated with the multicast address. Specifically, IPv6 provides for a Home Subscription procedure for supporting mobile multicast operation.

In order to join a multicast group using the Home Subscription approach, each MN establishes a tunnel with its HA and sends its multicast group membership control packet through it. When the HA receives the tunnelled multicast control packet, it decapsulates and forwards the packet to a local multicast router on the home link. The local multicast router intercepts the membership packet and sends a join message to the nearest on-tree router of the multicast delivery tree. Once the multicast branch is established, the HA forwards the incoming multicast packets down the tunnel to the mobile multicast receiver. In accordance with the Mobile IPv6 protocol, each MN that is away from its home network will after having joined the multicast group generate Correspondent Registration signaling to its multicast source (the CN).

Thus, each MN of the multicast group will generate Binding Update messages and transmit these to the CN. However, as mobile multicast becomes increasingly popular with more and larger multicast groups being in operation, the signaling traffic associated with the Correspondent Registration procedure will become significant and may use substantial communication resource. This may reduce the capacity of the communication system and may result in increased transmission and routing delays. Furthermore, the processing load on network nodes including the CN and MN may be increased.

Hence, an improved network node, method and network would be advantageous and in particular a system allowing for increased flexibility, increased capacity, reduced processing load, reduced delays, reduced communication resource usage and/or reduced overhead for supporting mobility would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a network node for a communication network, the network node comprising: means for receiving data from a first node of the network; means for determining a multicast characteristic of the first node; and means for selecting between a dynamic address update mode and a non-dynamic address update mode in response to the multicast characteristic.

The first node may be a corresponding node of the first network node. The network node may in particular be in a foreign network using a different address than in the home network. The dynamic address update mode may allow for messages to be transmitted to the first node to indicate address changes whereas the non-dynamic address update mode may comprise transmitting no such messages.

The invention may provide a reduced number of address update messages to be transmitted thereby reducing the communication resource use. The invention may increase capacity of the communication system, reduce bandwidth requirements and/or reduce transmission and/or queue lengths. Alternatively or additionally, the invention may reduce the processing load of one or more nodes of the network.

In particular, the inventors have realised that the utility and requirement as well as the impact of transmitting address updates may depend on whether the corresponding node is a multicast node for the network node or not. Thus, the inventors have realised that having an address update approach which is dependent on a multicast characteristic of the first node may improve performance. In particular, in many embodiments, such as for a Mobile IPv6 multicast communication, the address updates are not used by the corresponding node thereby increasing the resource consumption without providing any benefit. This may be effectively mitigated or eliminated in many embodiments in accordance with the present invention.

According to an optional feature of the invention, the multicast characteristic is an indication of whether the first node is a multicast only node with respect to the network node. A first node which is a multicast only node with respect to the network node is a node that does not transmit unicast data to the network node. This may improve performance of a communication system and may reduce the number of address update messages which are transmitted to multicast nodes.

According to an optional feature of the invention, the means for selecting is operable to select the non-dynamic address update mode only if the multicast characteristic indicates that the first node is a multicast only node with respect to the network node. This may improve performance of a communication system and may reduce the number of address update messages which are transmitted to multicast nodes.

According to an optional feature of the invention, the network node comprises means arranged to update the first node of an address change when in the dynamic address update mode and not to update the first node of the address change when in the non-dynamic address update mode. This may improve performance of a communication system and may specifically allow for a minimisation of transmission of address update messages when not needed by multicast nodes.

According to an optional feature of the invention, the address change is a network address change. The network address change may be from a first sub-network to a second sub-network. The first and second sub-networks may have different values of network address fields in the corresponding addresses such as different IPv6 network address fields. The address change may be between a foreign network and a home network. The feature may improve performance of a communication system.

According to an optional feature of the invention, the network node comprises means arranged to transmit at least one care-of-address to the first node when in the dynamic address update mode and not to transmit any care-of address to the first node when in the non-dynamic address update mode. This may reduce resource use of e.g. unicast communications by allowing direct routing to the network node while not necessitating care-of-address update signalling for e.g. multicast communications wherein care-of-addresses are not used. Hence, an optimisation of performance for the specific conditions may be achieved.

According to an optional feature of the invention, the network node is a mobile network node. The invention may allow for improved performance for moving networks and may in particular reduce the required communication bandwidth of the network.

According to an optional feature of the invention, the network node is a mobile router. A second (or more) network nodes may communicate with the first node through the network node which may operate as a router for these network nodes. The network node may for example be a Register Entity and the second node may be a Specific Node of an Internet Protocol communication network. The feature may improve performance in a communication system and in particular in a moving network.

According to an optional feature of the invention, the means for determining the multicast characteristic is operable to designate the first node as a multicast only node with respect to the network node if the means for receiving has received fewer than a threshold of unicast messages from the first node in a time interval.

This may provide for an efficient and/or accurate way of detecting a multicast node with respect to the network node. The time interval may be a static/predetermined time interval or may be a time interval which is determined in response to a parameter. For example, the time interval may be determined in response to a number of data packets received. The threshold may be any suitable value including 1. Hence, the means for determining the multicast characteristic may e.g. designate the first node is a multicast only node with respect to the network node if there have been no unicast data packets in the last N data packets received from the first node, where N is a suitably selected number.

According to an optional feature of the invention, the means for determining the multicast characteristic is operable to designate the first node as a multicast only node with respect to the network node when the network node is in a foreign network and has transmitted fewer than a threshold of messages directly to the first node in a time interval.

This may provide for an efficient and/or accurate way of detecting a multicast node with respect to the network node. The time interval may be a static/predetermined time interval or may be a time interval which is determined in response to a parameter. For example, the time interval may be determined in response to a number of data packets transmitted. The threshold may be any suitable value including 1. Hence, the means for determining the multicast characteristic may e.g. designate the first node is a multicast only node with respect to the network node if no data packets has been transmitted directly to first node in the last transmitted N data packets, where N is a suitably selected number. A direct transmission is a transmission which directly addresses the first node and may in particular be a transmission which is not transmitted through a home agent of the network node's home network.

According to an optional feature of the invention, the communication network is an Internet Protocol communication network. The communication network may for example be an IPv4 and/or IPv6 communication network. A communication network is in this context an IP communication network if the communication between the network node and the first node involves the Internet Protocol.

According to an optional feature of the invention, the network node comprises means arranged to perform a correspondent registration procedure when in the dynamic address update mode and not to perform the correspondent registration procedure when in the non-dynamic address update mode. The invention may provide improved performance by adapting the use of the correspondent registration procedure to the current multicast characteristics of the first node with respect to the network node.

According to an optional feature of the invention, the network node comprises means arranged to send binding update messages to the first node when in the dynamic address update mode and not to send binding update messages to the first node when in the non-dynamic address update mode. The invention may provide improved performance by adapting the transmission of binding update messages to the current multicast characteristics of the first node with respect to the network node.

According to a first aspect of the invention, there is provided a communication network comprising a network node having an associated home sub-network and foreign su-bnetwork and a first network node wherein the network node comprises: means for receiving data from the first node; means for determining a multicast characteristic of the first node; means for selecting between a dynamic address update mode and a non-dynamic address update mode in response to the multicast characteristic; and transmitting means arranged to transmit at least one care of address to the first node when in the dynamic address update mode and not to transmit any care of address to the first network when in the non-dynamic address update mode; and the first node comprises means for transmitting data to the network node using the care of address or a home network address of the network node; and the communication network further comprises means for routing the data from the first node to the network node through the home sub-network when the home network address is used and for routing the data from the first node to the network node without routing data through the home sub-network when the care of address is used.

According to an optional feature of the invention, the home sub-network comprises means for registering the network node for a multicast service using a home subscription procedure.

According to a first aspect of the invention, there is provided a method of operation for a network node of a communication network, the method comprising:
receiving data from a first node of the network; determining a multicast characteristic of the first node; and selecting between a dynamic address update mode and a non-dynamic address update mode in response to the multicast characteristic.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a communication network in accordance with some embodiments of the invention;

FIG. 2 illustrates a network node in accordance with some embodiments of the invention.

### DETAILED DESCRIPTION OF EMBODIMENTS OF THE INVENTION

The following description focuses on embodiments of the invention applicable to a communication network using an Internet Protocol (IP) such as an IP version 4 or version 6 protocol. However, it will be appreciated that the invention is not limited to this application but may be applied to many other communication networks.

The specific embodiments described in the following will focus on embodiments wherein a network node is a mobile node which moves in a communication network.

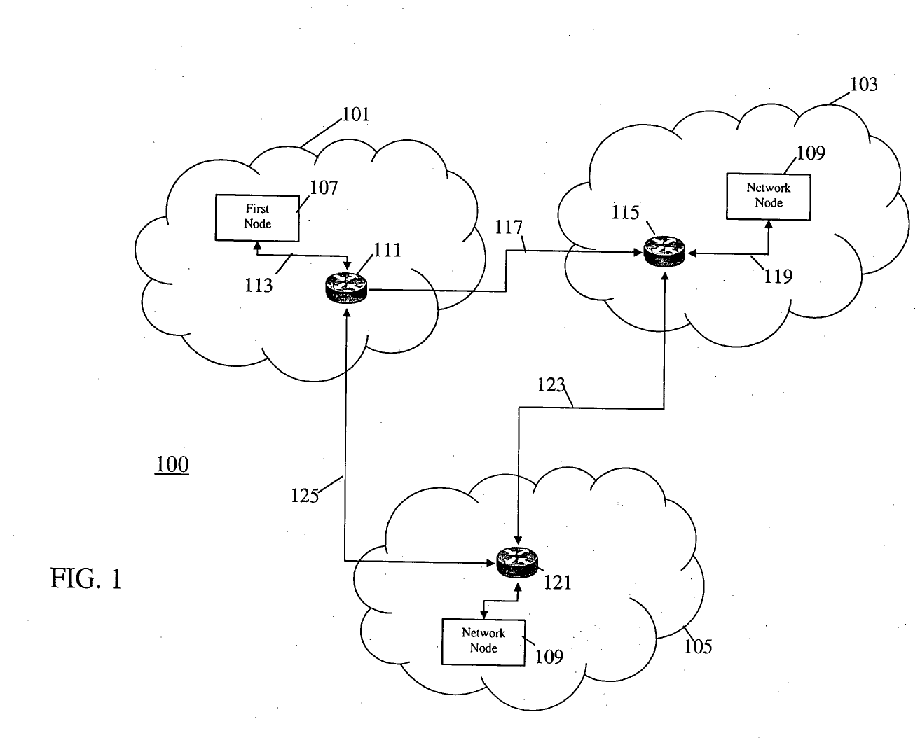

FIG. 1 illustrates a communication network 100 in accordance with an embodiment of the invention.

The communication network of FIG. 1 comprises three sub-networks, henceforth referred to as the source network 101, the home network 103 and the foreign network 105.

The source network 101 comprises a first node 107 that, in the example, comprises an application server which generates data that is transmitted to one or more other network nodes. In particular, the first node 107 transmits data to a network node 109 which in the example of FIG. 1 is a mobile node. Thus, using the terminology of the IETF (Internet Engineering Task Force), the network node 109 may be considered a Specific Node (SN) or a Mobile Node (MN) and the first node 107 may be considered a Corresponding Node (CN).

In the example, the first node 107 is coupled to a first routing element 111, located in the source network 101, over a communication link 113. The first routing element 111 is coupled to a second routing element 115, located in the home network 103, over a communication link 117. The network node 109 is coupled to the second routing element 115 through a communication link 119. Thus, data may be communicated between the foreign network 105 and the network node 109 via the first routing element 111 and the second routing element 115. It will be appreciated that for brevity and clarity, only one routing element is described for each sub-network but that communication networks typically comprises a large number of routing elements and that communication paths typically involve a significant number of routing elements.

In the example of FIG. 1, the network node 109 is a mobile node which may move physically and topologically in the communication network. In the example, the network node 109 is however associated with a specific home address and a home link. In the present case, the home address is an address of the home network 103 and the home link is the link 119.

In the example of FIG. 1, the second routing element 115 is not just a router but also comprises functionality for implementing a home agent for the network node 109. The home agent is operable to keep track of the network node's 109 current address and to intercept any data packets addressed to the home address of the network node 109 and to forward it to the current address.

Thus, the second routing element 115 maintains an association, known as a binding, between the home address of the network node 109 and a Care-of-Address (CoA) which is the network node's 109 current address. Any data packets that are addressed to the home address of the network node 109 will be routed to the second routing element 115 which is the network node's 109 home access point to the communication network. When the second routing element 115 comprises a binding to a CoA address for the network node 109, any data packets addressed to the home address are intercepted and forwarded to the CoA address. Specifically, the home agent encapsulates the data packet by adding a new IP header comprising the CoA address and transmits the encapsulated data packet to the CoA address by tunnelling.

In the example of FIG. 1, the network node 109 may have moved from its home location to a location in the foreign network 105. In the illustration, the network node 109 is also shown coupled to a third routing element 121, located in the foreign network 105, and coupled to the second routing element 115 over a communication link 123. When the network node 109 receives an address belonging to the foreign network 105, it transmits an address update message, known as a Binding Update in IP networks, to the second routing element 115 and specifically to the network node's 109 home agent. Accordingly, when the second routing element 115 receives a data packet addressed to the home address it transmits this to the network node 109 via the third routing element 121 and the communication link 123.

This approach allows an application which does not know the current location of the network node 109 to be able to address the network node 109 and thus to communicate to the network node 109 by using the home address. However, a problem associated with this approach is that the routing becomes inefficient as it inherently includes a double leg routing. For example, in FIG. 1, a data packet from the first node 107 must first be routed to the second routing element 115 and then from there to the third routing element 121.

Therefore, communication networks such as the Internet comprise facility for updating a Correspondent Node with information of the current address of mobile nodes. In particular, the network node 109 may not only send a Binding Update message to the home agent but may also send a Binding Update message directly to the Corresponding Node (the first node 107 in the present example). When the first node 107 receives the Binding Update message, it proceeds to transmit data to the network node 109 by using the CoA address rather than the home address. Accordingly, a more efficient routing may be achieved, e.g. by the data packets being routed directly from the first routing element 111 to the third routing element 121 via communication link 125.

In an IP network, the process for updating the Corresponding Node of the CoA is known as Correspondent Registration and in accordance with IPv6, this is a mandatory process which must be performed by all mobile network nodes regardless of the specific characteristics of the communication. However, the Inventor's have realised that there are a number of disadvantages with the conventional approach and that improved performance may be achieved by making the address update process conditional on a multicast characteristic of the Correspondent Node.

Specifically, the first node 107 may be a multicast node which transmits data to a plurality of network nodes by using a group or multicast address (A multicast communication comprises routing a data packet to a plurality of destinations rather than to one specific network node as for unicast. However, in contrast to broadcasting of data, a multicast node addresses a plurality of specific nodes sharing the same multicast address).

In accordance with the IP protocol, a network node may join a multicast group using what is known as the Home Subscription approach. In accordance with this approach, a network joins a multicast tree by the home agent connecting to a node of this multicast tree. A single multicast data packet may be transmitted from the first node 107 and routed to all nodes of the multicast tree. In particular, the nodes of the multicast tree comprise information of which destinations (i.e. the lower nodes of the tree) any data packets comprising the specified multicast address should be forwarded to. When the data packet reaches the node to which the home agent is coupled, the data packet is forwarded to the home agent which then forwards it to the home address or CoA of the network node 109 as appropriate.

However, as the same multicast address is typically used for a plurality or multiplicity of destinations, the first node 107 cannot use the specific CoA received from the network node 109. Thus, for such multicast situations, the address update messages are redundant and result in increased bandwidth usage and processing load of network nodes and communication links. As the popularity of multicast services is expected to increase explosively, the wasted bandwidth and processing resource is expected to become important and possibly critical in future communication networks.

In accordance with some embodiments of the current invention, the network node 109 comprises functionality for implementing an address update operation which is conditional on a multicast characteristic of the first node 107. Specifically, the network node 109 may determine if the Corresponding Node in the form of the first node 107 transmits only multicast data to the network node 109, and if so it may not transmit any address updates to the first node 107. However, if the first node 107 receives unicast data from the network node 109 or the first node 107 sends unicast data to the network node 109, the network node 109 may continue to transmit address updates thereby allowing the first node 107 to transmit this data through a more efficient route (such as directly from the first routing element 111 to the third routing element 121 through communication link 125).

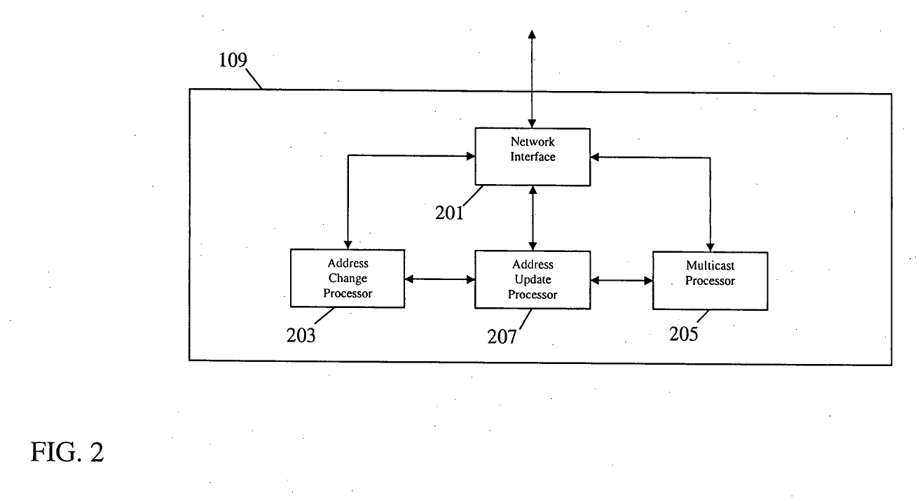

FIG. 2 illustrates the network node 109 of FIG. 1 in more detail.

The network node 109 comprises a network interface 201 which is operable to interface the network node 109 to the network and in particular to transmit and receive data from a router such as the second routing element 115 or the third routing element 121.

The network interface 201 is coupled to an (optional) address change processor 203 which is arranged to detect if the address of the network node 109 has changed and specifically is operable to detect if the network node 109 moves from being on the home link to being on a foreign link where it is assigned a new address.

The network interface 201 is furthermore coupled to a multicast processor 205 which is operable to determine a multicast characteristic of the Correspondent Node in the form of the first node 107.

The network interface 201, address change processor 203 and multicast processor 205 are further coupled to an address update processor 207. The address update processor 207 is operable to select between a dynamic address update mode and a non-dynamic address update mode in response to the multicast characteristic.

In the example, the multicast processor 205 is operable to determine whether the first node 107 is a multicast only node with respect to the network node 109. The first node 107 is a multicast only node with respect to the network node 109 if the network node 109 receives only multicast data from the first node 107. The first node 107 may transmit unicast or broadcast messages to other network nodes but will not transmit unicast data to the network node 109.

In the example, when the network node 109 is in the dynamic address update mode, the address update processor 207 is operable to transmit address update messages to the first node 107 but when the network node 109 is in the non-dynamic address update mode, no address updates are transmitted to the first node 107. Thus, when in the dynamic address update mode, any address change detected by the address change processor 203 will result in an address update message being sent but will not result in any transmission when the network node 109 is in the non-dynamic address update mode. It will be appreciated that when the network node 109 is in the dynamic address update mode, address updates may be transmitted at any appropriate time or in response to any appropriate event. For example, an address update may be transmitted when an address change is detected, at regular intervals or in response to an address update request from the first node 107.

The address update processor 207 is in the example operable to enter the non-dynamic address update mode when the multicast processor 205 designates the first node 107 as a multicast only node and to enter the dynamic address update mode when the multicast processor 205 designates the first node 107 as a not being a multicast only node.

Thus, the described embodiments may allow address updates to be optimized for the current communication characteristics and may accordingly substantially reduce the number of address update messages which are transmitted thereby reducing bandwidth requirements and/or processing loads. In particular, the described embodiments may allow for optimized routing for unicast services while minimising route optimization and address update signalling for multicast services.

Specifically for a mobile IPv6 network, the network node 109 is arranged for a Correspondent Registration operation which is conditional on whether the Corresponding Node as a unicast or multicast node form the point of view of the network node 109.

Thus, when the network node 109 is in the dynamic address update mode, the network node 109 proceeds to perform the Correspondent Registration procedure for the first node 107 and thus transmits care-of-address messages in the form of Binding Update messages to the first node 107.

In accordance with the Mobile IPv6 protocol the, the Binding Update messages are sent whenever the binding lifetime expires even though the network node 109 does not move topologically. Furthermore, every time the network node 109 moves topologically, a Binding Update message is transmitted. In response to receiving the Binding Update message, a Binding Update Acknowledgement message may be transmitted from the first node 107 to the network node 109. In case the network node 109 requests an acknowledgement message from the first node 107, retransmission of Binding Update messages will occur if the first node 107 does not send a Binding Update Acknowledgement message to the network node 109.

However, this significant message exchange is limited to situations wherein a substantial benefit may be achieved by an improved routing efficiency. In particular, when the first node 107 is a multicast only node (from the point of view of the network node 109), the network node 109 enters the non-dynamic address update mode wherein no Correspondent Registration procedure is instigated for the first node 107. Thus, no care-of-address messages or Binding Update messages are transmitted to the first node 107 thereby resulting a very substantial reduction in the signalling message exchange.

This reduction may be of particular significance when the network node 109 is a mobile wireless station communicating over an air interface having a limited communication capacity. For example, an important reduction in the air interface resource usage of a cellular communication system may be achieved.

The network node 109 may proceed to transmit Binding Updates to the home agent thereby allowing any multicast transmissions to be forwarded by the home agent to the current CoA of the network node 109.

The described embodiments may thus make Route Optimization procedures and/or Return Routability procedures conditional on a multicast characteristic of a Correspondent Node.

It will be appreciated that any suitable means of determining the multicast characteristic may be used.

For example, the multicast processor 205 may designate the first node 107 as a multicast only node (with respect to the network node 109) if the network node 109 has received fewer than a threshold of unicast messages from the first node in a time interval.

Specifically, the multicast processor 205 may monitor all data packets received from the first node 107 and if a data packet is received which comprises a unicast address, it will instantly designate the first node 107 as a non-multicast only node. However, if a predetermined number of consecutive data packets are received with all of them comprising the multicast address, the multicast processor 205 may designate the first node 107 as a multicast only node.

Alternatively or additionally, the multicast processor 205 may designate the first node 107 as a multicast only node (with respect to the network node 109) if the network node 109 has transmitted fewer than a threshold of messages directly to the first node 107 in a given time interval.

Thus, the multicast processor 205 may detect that all data packets to the first node 107 are transmitted via the home network rather than directly to the first node 107 and this may be an indication of the first node 107 being a multicast only node.

It will be appreciated that although the above description has focussed on embodiments where the network node 109 was the destination node for the data packets from the foreign network 105 this is not essential.

For example, the IP data packets may be communicated between the first node 107 (the Correspondent Node (CN)) and a Specific Node (SN) connected to the network through the network node 109. Thus, the network node 109 may be a Mobile Entity (ME) serving the SN and a Register Entity (RE) for the SN for the address change of the CoA of the ME. The network node 109 may thus be a Mobile Entity (ME) which may serve the SN or may itself be the SN.

Thus, the Correspondent Registration procedure may refer to a notification by any RE of the updated CoA of an ME to the CN of the SN that this ME represents.

As an example, the RE may operate the Correspondent Registration procedure conditionally on the multicast characteristic of the CN in the following way:
For a CN that does not have any unicast traffic to any SN represented by the ME, the RE does not activate the Correspondent Registration procedure for this CN.
For a CN that has unicast traffic to one or more SNs represented by the ME, if the Binding Update message is single-SN-based, the RE activates the Correspondent Registration procedure for this CN for each of these SNs with separate bindings of each relevant SN to the CoA of the ME.
For a CN that has unicast traffic to one or more SNs represented by the ME, if the Binding Update message is multiple-SN-based, the RE activates the Correspondent Registration procedure for this CN with a single or multiple grouped bindings of these SNs (e.g. a list of relevant SNs, one or more IP subnets, etc) to the CoA of the ME.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “first” etc do not preclude a plurality.

1. A network node for a communication network, the network node comprising
means for receiving data from a first node of the network;
means for determining a multicast characteristic of the first node; and
means for selecting between a dynamic address update mode and a non-dynamic address update mode in response to the multicast characteristic.

2. The network node claimed in claim 1 wherein the multicast characteristic is an indication of whether the first node is a multicast only node with respect to the network node.

3. The network node claimed in claim 2 wherein the means for selecting is operable to select the non-dynamic address update mode only if the multicast characteristic indicates that the first node is a multicast only node with respect to the network node.

4. The network node claimed in claim 1 wherein the network node comprises means arranged to update the first node of an address change when in the dynamic address update mode and not to update the first node of the address change when in the non-dynamic address update mode.

5. The network node claimed in claim 4 wherein the address change is a network address change.

6. The network node claimed in claim 1 wherein the network node comprises means arranged to transmit at least one care-of-address to the first node when in the dynamic address update mode and not to transmit any care-of-address to the first node when in the non-dynamic address update mode.

7. The network node claimed in claim 1 wherein the network node is a mobile network node.

8. The network node claimed in claim 1 wherein the network node is a mobile network router.

9. The network node claimed in claim 1 wherein the means for determining the multicast characteristic is operable to designate the first node as a multicast only node with respect to the network node if the means for receiving has received fewer than a threshold of unicast messages from the first node in a time interval.

10. The network node claimed in claim 1 wherein the means for determining the multicast characteristic is operable to designate the first node as a multicast only node with respect to the network node when the network node is in a foreign network and has transmitted fewer than a threshold of messages directly to the first node in a time interval.

11. The network node claimed in claim 1 wherein the communication network is an Internet Protocol communication network.

12. The network node claimed in claim 11 wherein the network node comprises means arranged to perform a correspondent registration procedure when in the dynamic address update mode and not to perform the correspondent registration procedure when in the non-dynamic address update mode.

13. The network node claimed in claim 11 wherein the network node comprises means arranged to send binding update messages to the first node when in the dynamic address update mode and not to send binding update messages to the first node when in the non-dynamic address update mode.

14. The network node claimed in claim 11 wherein the Internet Protocol is the Internet Protocol version 6.

15. The network node claimed claim 11 wherein the Internet Protocol is the Internet Protocol version 4.

16. A communication network comprising a network node having an associated home subnetwork and a foreign subnetwork and a first network node wherein the network node comprises:
means for receiving data from the first node;
means for determining a multicast characteristic of the first node;
means for selecting between a dynamic address update mode and a non-dynamic address update mode in response to the multicast characteristic; and
transmitting means arranged to transmit at least one care of address to the first node when in the dynamic address update mode and not to transmit any care of address to the first node when in the non-dynamic address update mode; and
the first node comprises
means for transmitting data to the network node using the care of address or a home network address of the network node; and
the communication network further comprises
means for routing the data from the first node to the network node through the home subnetwork when the home network address is used and for routing the data from the first node to the network node without routing data through the home subnetwork when the care of address is used.

17. The communication network claimed in claim 16 wherein the home subnetwork comprises means for registering the network node for a multicast service using a home subscription procedure.

18. A method of operation for a network node of a communication network, the method comprising:
receiving data from a first node of the network;
determining a multicast characteristic of the first node; and
selecting between a dynamic address update mode and a non-dynamic address update mode in response to the multicast characteristic.
